(19) United States
(12) Patent Application Publication
(10) Pub. No.: US 2013/0290860 A1
(43) Pub. Date: Oct. 31, 2013

(54) WORKSPACE INTERFACES, METHODS, AND SYSTEMS

(71) Applicants: Ann Lethers, Fremont, CA (US); Yasunori Ikeno, Santa Clara, CA (US)

(72) Inventors: Ann Lethers, Fremont, CA (US); Yasunori Ikeno, Santa Clara, CA (US)

(73) Assignee: Olympus Integrated Technologies America, Inc., San Jose, CA (US)

(21) Appl. No.: 13/460,702

(22) Filed: Apr. 30, 2012

(51) Int. Cl. G06F 3/048

(52) U.S. Cl. 715/744

(57) ABSTRACT

Systems that include user interfaces for handling images may deal with large amounts of image data, such as magnified medical images. Such systems may benefit by workspace interfaces, methods, and systems. For example, a method can include providing a workspace in a graphical user interface by a machine. The workspace can be located in a fixed location with respect to a plurality of applications. The method can also include sharing, by the workspace, content between or among the plurality of applications. The content can include at least one of a set of predefined functions or dynamically generated data.

### BACKGROUND

1. Field

Systems that include user interfaces for handling images may deal with large amounts of image data, such as magnified medical images. Such systems may benefit by workspace interfaces, methods, and systems.

2. Description of the Related Art

In certain conventional user interfaces, a user may be presented with row after row of thumbnail images corresponding to magnified medical images. These thumbnail images may, in certain cases, be very similar to one another, or may be related to one another in a way that is not reflected by the way in which the interface sorts the images.

For example, a user interface may present the thumbnail images based on a creation date, a modification date, or a name of the thumbnail image. However, images that are related for a user's purposes may not be located close to one another with respect to such a layout.

Moreover, images that are related may be located in different directories or folders.

### SUMMARY

A method, according to certain embodiments, includes providing a workspace in a graphical user interface by a machine. The workspace is located in a fixed location with respect to a plurality of applications. The method also includes sharing, by the workspace, content between or among the plurality of applications. The content includes at least one of a set of predefined functions or dynamically generated data.

In certain embodiments, an apparatus includes a user interface configured to provide a workspace. The workspace is located in a fixed location with respect to a plurality of applications. The apparatus also includes a sharing section configured to share, by the workspace, content between or among the plurality of applications. The content includes at least one of a set of predefined functions or dynamically generated data.

An apparatus, in certain embodiments, includes workspace means for providing a workspace in a graphical user interface by a machine. The workspace is located in a fixed location with respect to a plurality of applications. The apparatus also includes sharing means for sharing, by the workspace, content between or among the plurality of applications. The content includes at least one of a set of predefined functions or dynamically generated data.

### BRIEF DESCRIPTION OF THE DRAWINGS

For proper understanding of the invention, reference should be made to the accompanying drawings, wherein:

FIG. 1 illustrates web application architecture tiers.

FIG. 2 illustrates sharing of three selected images in a workspace according to certain embodiments.

FIG. 3 illustrates display of an image with a workspace stationed according to certain embodiments.

FIG. 4 illustrates two slide images selected into a workspace and given a case name according to certain embodiments.

FIG. 5 illustrates real-time addition of content to a case according to certain embodiments.

FIG. 6 illustrates a tile pyramid according to certain embodiments.

FIG. 7 illustrates tiles of different ranks according to certain embodiments.

FIG. 8 illustrates a method according to certain embodiments.

FIG. 9 illustrates a system according to certain embodiments.

### DETAILED DESCRIPTION

A product for a user interface can be built by presenting a group of controls on the screen. When the user clicks on a control, some actions are triggered. These actions can be carried out for a specific purpose. For example, a button is one kind of control. The button's action could be pronouncing a vocabulary, so the user can learn how to say the word displayed next to the button.

Building products, such as software products, for user interfaces can come to an issue of limited monitor screen space. For example, in a medical imaging software product the amount of images to the amount of monitor screen space may be very disproportionate. An image may be considered by the user to be the most important element in such product, and it takes a big space to display the image. All other essential functions may have to be streamlined into a small space in order to maximize the presentation of images as a fraction of the screen space. In case it is not an option to show all the functions, a separate page or tab can be utilized to yield more space.

However, with a separate page or tab, the user may have to make multiple clicks to perform a single task. Crossing pages can cause some information hidden temporarily.

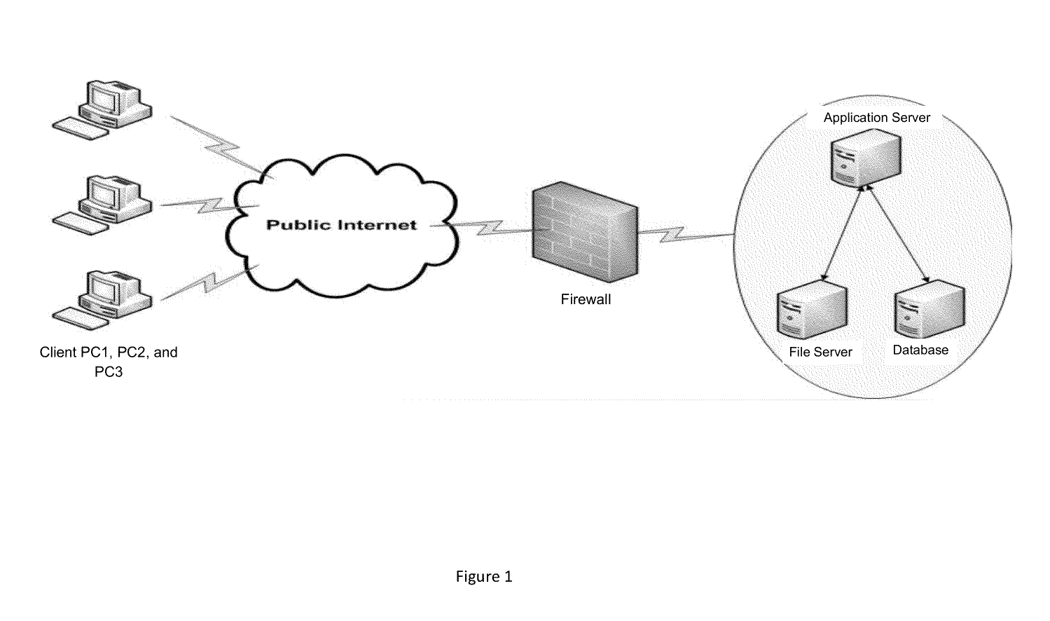

FIG. 1 illustrates web application architecture tiers. For a web application, the hardware architecture is more involved than the traditional desk top application. The basic concept of such architecture is shown in FIG. 1.

The flow of data can start with the client sending a request to the application server according to the user's interaction. Data can be retrieved by the application server from a file server and/or database. Data can then be sent back to the requesting client personal computer (PC) or other terminal computer.

This process can face some traffic challenges when navigating through a lot of network components. Degradation of performance compared to a local system may be inevitable. Accordingly, certain embodiments of a workspace can aid performance and may overcome or ameliorate these difficulties.

The workspace according to certain embodiments may have several aspects, as described below. In a first aspect, the workspace can provide a shared area.

The workspace can be a space shared by multiple pages or tabs. When a page or tab is changed, this space can be stationed and seen at all times. Without this area, the user may have to switch tabs or pages. The frequent clicks to switch screens can affect the user experience. For implementation, there is no restriction as to where the workspace is located, as long as it is shared. Not only the space, but also the content, is shared. The content can be a set of predefined functions or dynamically generated data. In this discussion, the emphasis is on the dynamically generated data for purposes of providing an example.

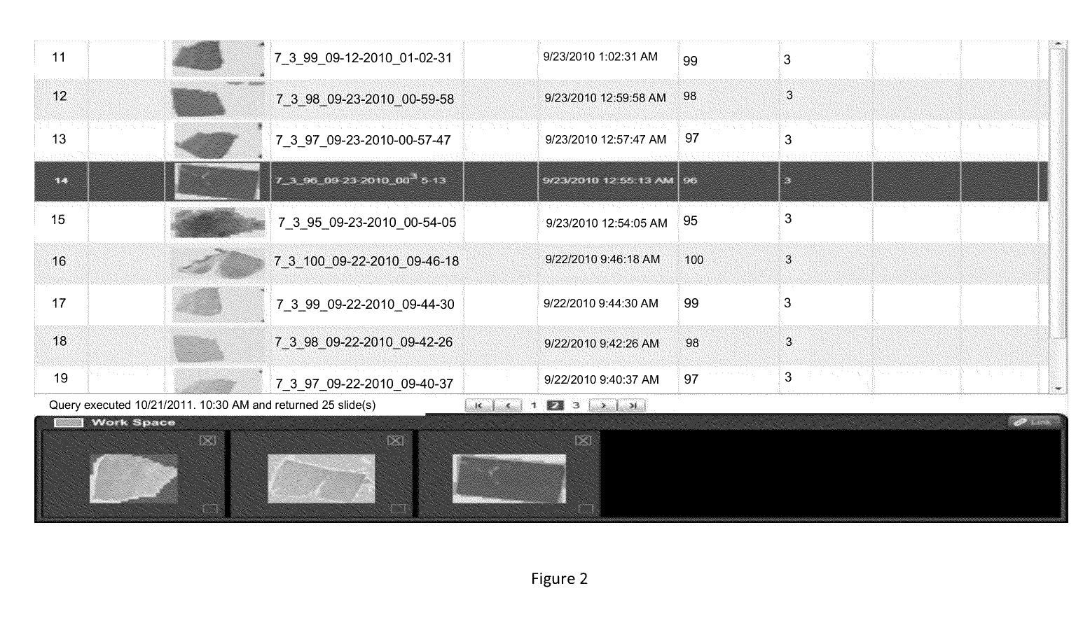

FIG. 2 illustrates sharing of three selected images in a workspace according to certain embodiments. As shown, there is a list of images in an application and three of them have been selected into the workspace.

When the image is ready to be viewed, the user can simply double-click on the image in the workspace. The image can then be displayed in the same area as the list is currently sown. The application for displaying the image on the list can be different from the application that displays the list.

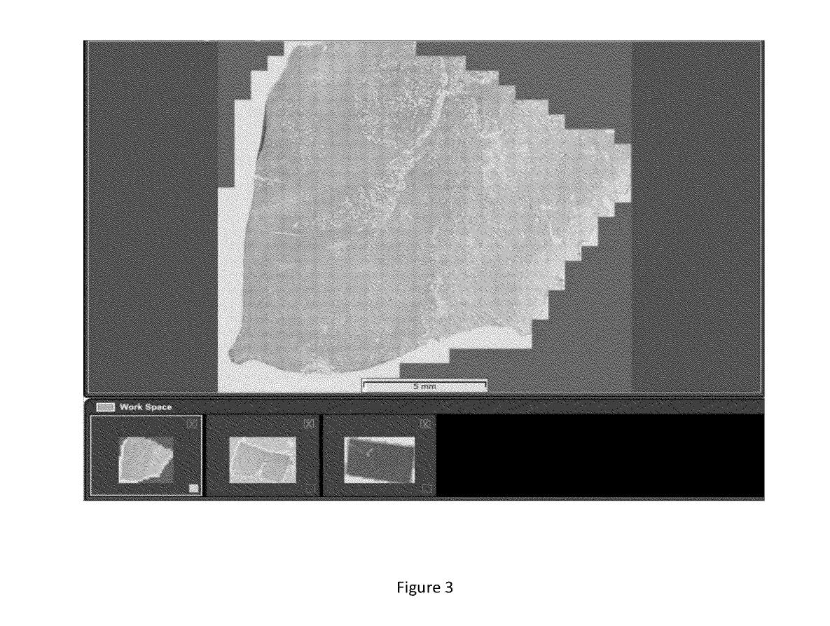

FIG. 3 illustrates display of an image with a workspace stationed according to certain embodiments. As shown in FIG. 3, the workspace can be stationed while the list area now displays the image.

The user can display a different image by selecting another image from the workspace, without going back to the list. If the user desires to go back to the list, a button or tab can be provided in the workspace. Upon clicking on the button, a screen can be shown as illustrated in FIG. 2, and additionally a button can be provided for to returning to the image display application.

In a second aspect, the workspace can provide task grouping. In certain embodiments, the workspace content can be automatically populated. For example, if a doctor wants to see all slide images for a case, the software can search all slide images with the same case identification (id) and add them into the workspace with one command of selecting a case.

Alternatively or in addition a user can also select items into the workspace manually. To use the previous example, a doctor can select a sub-set of the images of a case, mix images with different cases, or images that do not belong to any case, for a new case. At the end of the selection, a new case id can be assigned by the user.

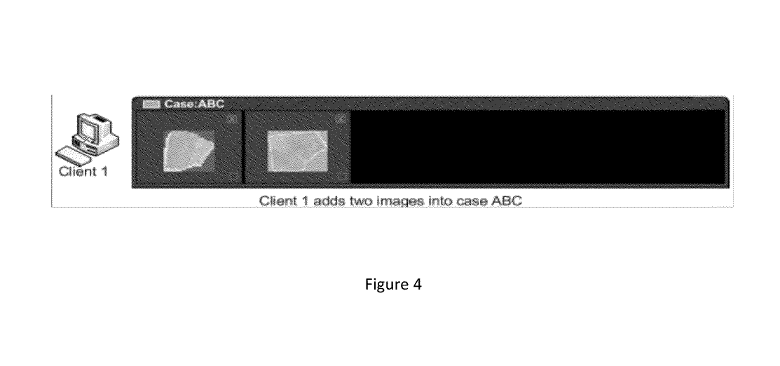

FIG. 4 illustrates two slide images selected into a workspace and given a case name according to certain embodiments. As can be seen in FIG. 4, two slide images have been selected into the workspace and given the case name ABC. Case ABC can be revisited by the user at a later time. The content of the case, for example the list of content that is included in the case, can be revised as well at any time.

The grouping function can be performed at read-time and/or in real time. This grouping function can be very useful for a conferencing or consultation scenario. If two doctors are having a consultation session, either one can insert or remove images from the workspace as needed. The workspace content can be synchronized, namely kept in sync, for both users during the session and/or can be saved.

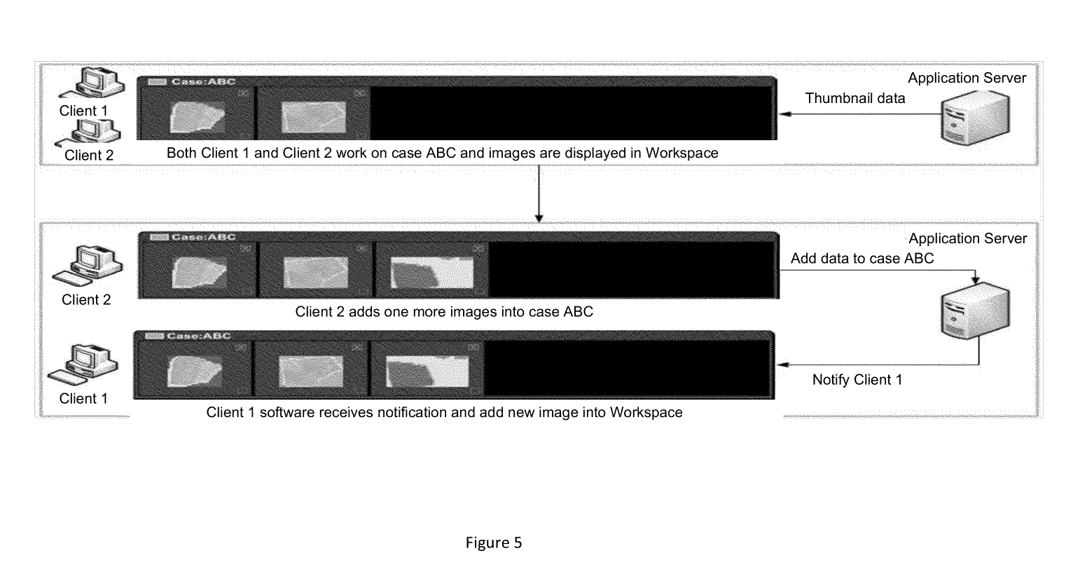

FIG. 5 illustrates real-time addition of content to a case according to certain embodiments. Specifically, Figure shows instant feedback, in which a new image can be added to case ABC in real-time. In addition to grouping for conference or consultation, grouping can be further categorized for patient reports, memos, audits, tasks for pathologists or any individual, and the like.

In a third aspect, the workspace can provide early timing. For example, medical image size can often be on scale of multiple gigabytes (GBs). Technically, it may be the case that it is not possible to load the entire image into computer memory at one time for a variety of reasons, such as limitations of a client computer, which may be a PC, smart phone, tablet, or personal digital assistant (PDA), including limitations on the size and resolution of the user's display or memory. Other limitations may include limitations, in terms of speed or cost, on transferring large amounts of data over a network, which may be a wireless network.

A pyramid of tiles representing an image can be used to facilitate the display. The high level description of the tile pyramid can be to divide the entire image into individual tiles of a certain size, such as 256×256 pixels. These tiles can have a particular resolution level. A next lower resolution level can be built by shrinking the previous resolution level to ¼ of its size and dividing the image into tiles with the same tile size. This process can be repeated at successive levels until the entire image is shrunk into a single tile, which can be a thumbnail image of the image. To display an image, the system can start with the single tile, for example the thumbnail, to allow the user to see the entire image in a small scale. As the user zooms in, the next layer tiles can be fetched. The neighboring tiles are fetched for panning operation.

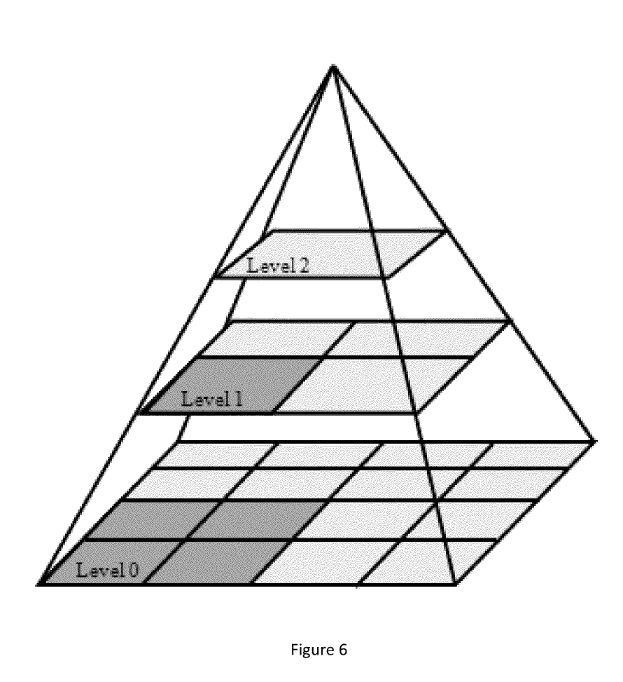

FIG. 6 illustrates a tile pyramid according to certain embodiments. More particularly, FIG. 6 illustrates a tile pyramid consisting of three resolution levels, although a tile pyramid in practice can have many more levels.

The tiles can be saved on a file server in a variety of different formats, such as JPEG, TIFF, BMP, GIF, and PNG. The tiles can even be saved in raw bytes and stored in a preparatory file or database. During runtime, these tiles can be read or opened by an application server and sent through the network to the client when requests are sent by the client.

While a selected slide image is sitting in the workspace, some data fetching can be triggered, which can be considered pre-fetching. This action can make data ready in a different format by getting it from the storage into the memory. The cached data can include image metadata and byte stream for tiles. Extra process can also be done at this time such as image quality corrections. Gamma correction, matrix correction, and image smoothing adjustment are some examples of image quality corrections.

The strategy of caching data can be useful. The tile caching can start on the server. The application server can read the tile file(s) from the file server disk or wherever it is stored, extract pixel data into server memory as bytes. The application server can also load the metadata into server memory once for the waiting image.

The caching can start with the lowest resolution tiles. Normally, the thumbnail level includes one or two tiles. Then, sequentially, caching can be moved up to the next upper level. This can be performed concurrently with the tile ranking process described below.

The more critical tiles can be cached into server memory first, as they carry more information and may be considered more interesting to the users. On the other hand, tiles with the most background colors are less critical. By comparing the compressed file size of two tiles of the same resolution, the one with larger size may be considered to have more information. This tile can be cached before others. The ranking process can also utilize image comparison technology for higher accuracy.

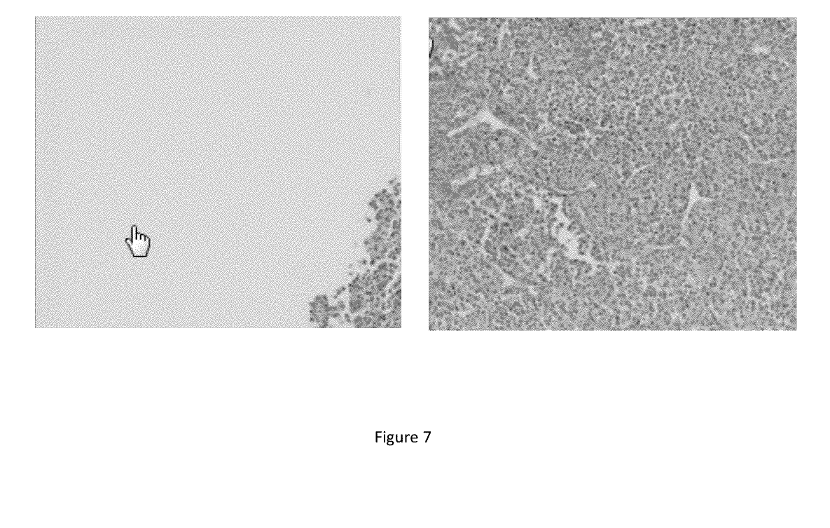

FIG. 7 illustrates tiles of different ranks according to certain embodiments. For example, as shown in FIG. 7, the right tile has higher rank than the left tile. The left tile is mostly background, with only a small amount of content of interest, whereas the right tile is almost entirely content of interest, as shown.

In a fourth aspect, the workspace can provide image pyramid file download. A separate thread or asynchronous call can start at the same time as the server caching. This thread can be responsible for transferring the image pyramid file(s) and/or other data files from the server to the client PC. For security reasons, any file saved on the client's hard drive may require the user's acknowledgement. Having proper coding, the cached data can be stored on the local hard drive in a way that bypasses this kind of restriction. Saving data, as distinct from an executable program, on the client's memory need not violate security and can provide faster access to the data.

After file transfer is completed, server caching can be stopped. All the subsequent tile or data fetching can be done only on the client side. Thus, the local performance can be improved due to eliminating the network traffic to be performed in real-time and distributing the computing power from the server to the client.

As technology improves, users may continue to demand higher resolution image to be generated and viewed in various fields with better user experience. The workspace can help in delivery of presentation that can meet such an expectation.

Accordingly, in certain embodiments, a workspace includes a bridge holding slide images or any dynamically generated data items in between multiple tabs or screens. The workspace can, in certain embodiments, greatly increase the screen usability and reduce user intervention.

Moreover, in certain embodiments the workspace can hold multiple items belong to the same category. For example, the workspace can include a set of images that have the same case id or are used for a tumor board.

Furthermore, in certain embodiments, a workspace can serve as an operational time buffer. While images or any items are sitting in the workspace and the user is performing a less computationally intense process, some time consuming or computationally intense processes can start with a different thread. The process can transform the data format and location for more efficient access.

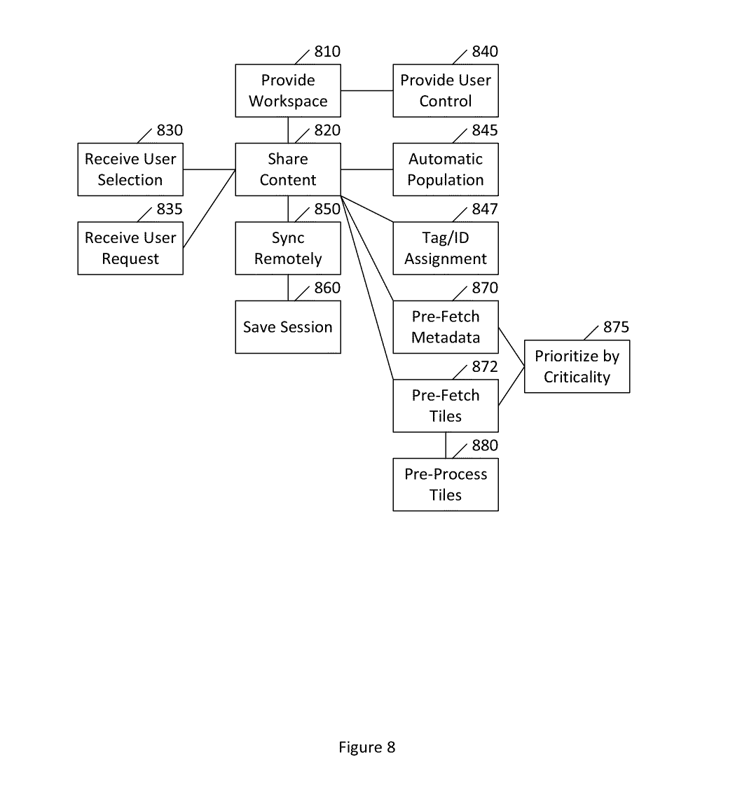

FIG. 8 illustrates a method according to certain embodiments. As shown in FIG. 8, a method can include, at 810, providing a workspace in a graphical user interface by a machine. The workspace can be located in a fixed location with respect to a plurality of applications. In other words, the position of the workspace in the user's graphical user interface can remain constant and the workspace can be visible regardless of which of several applications the user is using.

The method can also include, at 820, sharing, by the workspace, content between or among the plurality of applications. The content can include at least one of a set of predefined functions or dynamically generated data. For example, the content can include both the set of predefined functions and the dynamically generated data or just dynamically generated data.

The method can further include, at 830, receiving a selection of content from a user. In this case, the sharing can include presenting a representation of the user selected content in the workspace. The representation can be, for example, a file name or a thumbnail image. The method can additionally include, at 835, receiving a user request for content in the workspace. The sharing can, in this case, include providing the content to an application, such as an application that displays the content with more detail.

The method can additionally include, at 840, providing a control for allowing a user to select a previously used application from the workspace. Other user controls can also be provided, such as controls for manipulating the content in the workspace, some of which are described below.

The method can include, at 845, automatically populating the content of the workspace based on user selection of a tag, task, or case. For example, a user control can permit the entry of a tag, task, or case identification and the system can search for, and include in the workspace, matching images. Alternatively, the control can offer to the user to obtain all related images based on metadata for a particular image.

The method can also include, at 847, assigning a case identifier, task identifier, or tag to a plurality of items of the content based on a user selection. This can be in response to a manual one-by-one or batch selection and indication by the user via a user control.

The sharing can further include, at 850, sharing the workspace between a plurality of remote terminals. For example, two doctors can collaborate regarding medical images and can, for a session, share a single workspace. This workspace can be independent of the particular applications for each of the doctors. Thus, for example, the doctors can independently be reviewing or viewing images, while the workspace can be provided in synchronization between the two terminals, such that when one doctor adds an image to the workspace, it is available to both doctors via the workspace. Thus, the sharing can include updating the content in the workspace at a local terminal based on a selection at a remote terminal.

At 860, the method can include saving a session of the workspace upon receiving a user instruction.

The method can further include a variety of pre-fetching features. For example, at 870, the method can include fetching metadata corresponding to an item of content in the workspace prior to a user requesting the metadata. Likewise, at 872, the method can include fetching a plurality of tiles corresponding to an item of content in the workspace prior to a user requesting to view the content, wherein the tiles are tiles of a tile pyramid below the top layer of the tile pyramid. At 875, the method can include prioritizing the fetching based on the criticality of each of the plurality of tiles. This can apply to the fetching of the tiles themselves, but also to the fetching of the metadata.

The method can additionally include, at 880, performing processing on the plurality of tiles prior to the user requesting to view the content, wherein the processing comprises image quality correction.

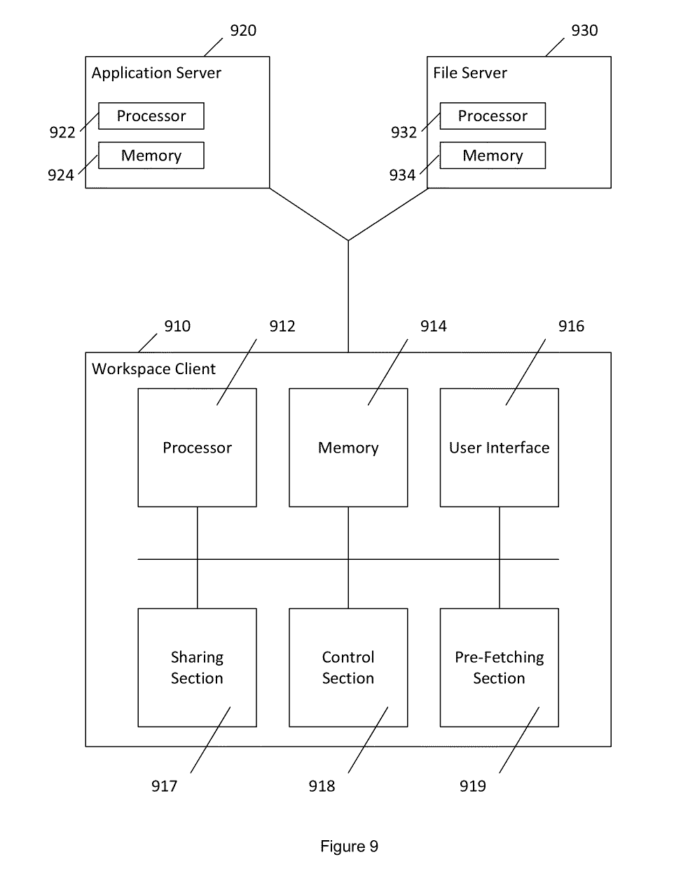

FIG. 9 illustrates a system according to certain embodiments. As shown in FIG. 9, the system can include a workspace client 910, which can be configured to operate in connection with an application server 920, and a file server 930.

Each of the workspace client 910, the application server 920, and the file server 930 can include at least one processor (respectively 912, 922, and 923), and at least one memory (respectively 914, 924, 934), which can include computer program instructions, such as software. The memory can be a non-transitory computer readable medium. Other hardware can also be included in each of the devices.

For example, the workspace client 910 can include a user interface 916. The user interface can be configured to operate a graphical user interface to display a workspace to a client.

The workspace client 910 can include a sharing section 917 that is configured to share content with respect to the workspace and a control section 918, which is configured to provide client controls so that the user can instruct the workspace client in a variety of ways, such as those described above. The workspace client 910 can additionally include a pre-fetching section 919, which can be configured to perform a variety of pre-fetching tasks, in coordination with the application server 920 and the file server 930.

Communication hardware, not shown, can be included in each of the devices to permit them to communicate with one another. The devices are shown connected in a star, but other logical or structural interconnections can be used. For example, there is no requirement that the file server 930 and the workspace client 910 be in communication with one another.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
providing a workspace in a graphical user interface by a machine, wherein the workspace is located in a fixed location with respect to a plurality of applications; and
sharing, by the workspace, content between or among the plurality of applications, wherein the content comprises at least one of a set of predefined functions or dynamically generated data.

2. The method of claim 1, further comprising:
receiving a selection of content from a user, wherein the sharing comprises presenting a representation of the user selected content in the workspace based on the user selection.

3. The method of claim 1, further comprising:
receiving a user request for content in the workspace, wherein the sharing comprises providing the content to an application based on the user request.

4. The method of claim 1, further comprising:
providing a control for allowing a user to select a previously used application from the workspace.

5. The method of claim 1, further comprising:
automatically populating the content of the workspace based on user selection of a tag, task, or case.

6. The method of claim 1, further comprising:
assigning a case identifier, task identifier, or tag to a plurality of items of the content based on a user selection.

7. The method of claim 1, wherein the sharing further comprises sharing the workspace between a plurality of remote terminals.

8. The method of claim 7, further comprising:
updating the content in the workspace at a local terminal based on a selection at a remote terminal.

9. The method of claim 1, further comprising:
saving a session of the workspace upon receiving a user instruction.

10. The method of claim 1, further comprising:
fetching metadata corresponding to an item of content in the workspace prior to a user requesting the metadata.

11. The method of claim 1, further comprising:
fetching a plurality of tiles corresponding to an item of content in the workspace prior to a user requesting to view the content, wherein the tiles are tiles of a tile pyramid below the top layer of the tile pyramid.

12. The method of claim 11, further comprising:
performing processing on the plurality of tiles prior to the user requesting to view the content, wherein the processing comprises image quality correction.

13. The method of claim 11, further comprising:
prioritizing the fetching based on the criticality of each of the plurality of tiles.

14. An apparatus, comprising:
a user interface configured to provide a workspace, wherein the workspace is located in a fixed location with respect to a plurality of applications; and
a sharing section configured to share, by the workspace, content between or among the plurality of applications, wherein the content comprises at least one of a set of predefined functions or dynamically generated data.

15. The apparatus of claim 14, wherein the user interface is configured to receive a selection of content from a user, wherein the sharing section is configured to present a representation of the user selected content in the workspace based on the user selection.

16. The apparatus of claim 14, wherein the user interface is configured to receive a user request for content in the workspace, wherein the sharing section is configured to provide the content to an application based on the user request.

17. The apparatus of claim 14, further comprising:
a control section configured to provide a control for allowing a user to select a previously used application from the workspace.

18. The apparatus of claim 14, wherein the sharing section is configured to automatically populate the content of the workspace based on user selection of a tag, task, or case.

19. The apparatus of claim 14, wherein the sharing section is configured to assign a case identifier, task identifier, or tag to a plurality of items of the content based on a user selection.

20. The apparatus of claim 14, wherein the sharing section is configured to share the workspace between a plurality of remote terminals.

21. The apparatus of claim 20, wherein the sharing section is configured to update the content in the workspace at a local terminal based on a selection at a remote terminal.

22. The apparatus of claim 14, wherein the sharing section is configured to save a session of the workspace upon receiving a user instruction.

23. The apparatus of claim 14, further comprising:
a pre-fetching section configured to fetch metadata corresponding to an item of content in the workspace prior to a user requesting the metadata.

24. The apparatus of claim 14, further comprising:
a pre-fetching section configured to fetch a plurality of tiles corresponding to an item of content in the workspace prior to a user requesting to view the content, wherein the tiles are tiles of a tile pyramid below the top layer of the tile pyramid.

25. The apparatus of claim 24, wherein the pre-fetching section is configured to perform processing on the plurality of tiles prior to the user requesting to view the content, wherein the processing comprises image quality correction.

26. The apparatus of claim 24, wherein the pre-fetching section is configured to prioritize fetching based on the criticality of each of the plurality of tiles.

27. An apparatus, comprising:
workspace means for providing a workspace in a graphical user interface by a machine, wherein the workspace is located in a fixed location with respect to a plurality of applications; and
sharing means for sharing, by the workspace, content between or among the plurality of applications, wherein the content comprises at least one of a set of predefined functions or dynamically generated data.
